(19) United States
(12) Patent Application Publication
(10) Pub. No.: US 2015/0331400 A1
(43) Pub. Date: Nov. 19, 2015

(54) System and Method for use in Automation Technology

(71) Applicant: ENDRESS+HAUSER GMBH-CO., Maulburg (DE)

(72) Inventors: Eric Birgel, Schopfheim (DE); Simon Zuhlke, Schopfheim (DE); Stefan Maier, Rheinfelden (DE); Amend Zenuni, Lorrach (DE)

(21) Appl. No.: 14/652,811

(22) PCT Filed: Dec. 6, 2013
(86) PCT No.: PCT/EP2013/075745

§ 371 Date: Jun. 17, 2015

(30) Foreign Application Priority Data
Dec. 21, 2012 (DE) 10 2012 112 842.1

(51) Int. Cl. G05B 15/02

(52) U.S. Cl. CPC G05B 15/02

(57) ABSTRACT

A system for use in automation technology, especially in process and/or manufacturing automation technology, comprising: at least one field device equipped with a basic firmware, wherein the field device is configurable for a specific application by means of a specific application firmware; a superordinated unit, via which the at least one field device can be serviced, wherein, for servicing, a first operating program is provided and the first operating program has a service program part corresponding to the specific application firmware; and a bus, via which the superordinated unit communicates with the at least one field device by means of the operating program.

The invention relates to a system for use in automation technology, especially in process and/or manufacturing automation technology.

Furthermore, the invention relates to a method for configuring a system of automation technology, especially process- and/or manufacturing automation technology.

In automation technology, especially in process automation technology, field devices are often applied, which serve for registering and/or influencing process variables. Serving for registering process variables are sensors, such as, for example, fill level measuring devices, flow measuring devices, pressure- and temperature measuring devices, pH-redox potential measuring devices, conductivity measuring devices, etc., which register the corresponding process variables, fill level, flow, pressure, temperature, pH-value, and conductivity. Serving for influencing process variables are actuators, such as a, for example, valves or pumps, via which the flow of a liquid in a pipeline section, respectively the fill level in a container, can be changed. Referred to as field devices are, in principle, all devices, which are applied near to the process and which deliver, or process, process relevant information. In connection with the invention, field devices include thus especially also remote I/Os, radio adapters, and, in general, all devices, which are arranged at the field level. A large number of such field devices are manufactured and sold by the firm, Endress+Hauser.

In modern process plants, communication between at least one superordinated unit and the field devices occurs, as a rule, via a bus system, such as, for example, Profibus® PA, Foundation Fieldbus® or HART®. The bus systems can operate by wire or wirelessly. The superordinated unit serves for process control, for process visualizing, for process monitoring, as well as for start-up and servicing of the field devices and is also referred to as a configuration/management system. Programs, which run self-sufficiently on superordinated units, include, for example, the operating, or servicing, tool, respectively operating program, FieldCare of the group of firms, Endress+Hauser, the operating, or servicing, tool Pactware, the operating, or servicing, tool AMS of Fisher-Rosemount and the operating, or servicing, tool PDM of Siemens. Operating tools, which are integrated in control system applications, include PCS7 of Siemens, Symphony of ABB and Delta V of Emerson. The terminology ‘servicing of field devices’ includes especially the configuring and parametering of field devices, however, also diagnosis for the purpose of early detection of defects in the field devices or in the process.

The integration of field devices in configuration/management systems occurs usually via device descriptions, which care for assuring that the configuration/management systems can detect and interpret the data sets delivered from the field devices. The device descriptions for each field device type, respectively for each field device type in different measuring points/applications, are provided, as a rule, by the respective device manufacturers.

In order that the field devices can be integrated in different fieldbus systems, different device descriptions must be created for the different fieldbus systems. Thus, there are—to name only some examples—HART-, Fieldbus Foundation- and Profibus device descriptions. The number of device descriptions is very large and corresponds to the large number of different field devices, respectively field device types, in different measuring points, respectively in different applications and in different bus systems. Usually the device descriptions are stored in the respective configuration/management systems. Added to this picture is the fact that, due to the continuing development of the field devices, the device descriptions need to be updated for the changed functionality.

For the purpose of creating a unitary description language for field devices, the Fieldbus Foundation (FF), the HART Communication Foundation (HCF) and the Profibus User Organization (PNO) have created a unified electronic device description language (Electronic Device Description Language EDDL). The EDDL and the corresponding Electronic Device Description EDD are defined in the standard IEC 61804-2.

Besides the above described device descriptions, in increasing measure, so-called Device Type Managers (DTM), respectively device managers or device drivers, are applied, which require as runtime environment a frame, respectively a frame application. DTMs allow for comprehensive servicing of the field devices and correspond especially to the FDT—Field Device Tool—Specification. The FDT Specification, which is an industrial standard, is an interface specification and was developed by PNO—Profibus User Organisation—in cooperation with ZVEI—Zentralverband Elektrotechnik- and Elektroindustrie (German Electrical and Electronic Manufacturers' Association). The current FDT Specification is obtainable from ZVEI, PNO, or the FDT Group.

All of the above mentioned definitions can be applied in connection with the solution of the invention.

Furthermore, field devices have, as a rule, a number of modules, respectively assemblies, each which involves hardware and firmware associated with the hardware. As a part of the manufacturing, the individual modules are so combined with one another and their firmware so matched to one another that the firmware of the individual modules of the field device are compatible with one another (internal compatibility, respectively internal interoperability). The total software, respectively total firmware, of the field device is formed, respectively generated, from the firmware of the individual modules of a field device (and, in given cases, additional firmware- and/or software components of the field device). The field of use, respectively application, of the field device is defined based on this total software, respectively total firmware. Thus, for example, a field device is configured and correspondingly applied for measuring, for example, fill level or pressure.

Over the lifetime of an automated plant, for the most varied of reasons, changes in the plant and/or the field devices become necessary. For example, a change is necessary, when the functionality of the plant is to be expanded and/or the functionality of the field device needs to be changed. For example, it can be necessary to replace a field device with a field device of changed, respectively expanded, functionality. For this, currently, the field device integrated in the automated plant must be replaced with a new field device, which has the corresponding functionality. This means not only that the old field device must be removed (typically) manually from the automated plant and the new one, in turn, installed, but, instead, also, that the operator of the automated plant must obtain the new field device with the corresponding functionality, while, in contrast, the old field device removed from the plant is then, as a rule, left without a job.

It is, thus, an object of the invention to provide a system for use in automation technology, as well as a method for configuring a system, with whose help an increased user-friendliness, especially a more flexible adapting to application, is achieved.

is The object is achieved by a system and a method.

As regards the system, the object is achieved according to the invention by a system for use in automation technology, especially in process and/or manufacturing automation technology, wherein the system includes:
at least one field device equipped with a basic firmware, wherein the field device is configurable for a specific application by means of a specific application firmware;
a superordinated unit, via which the at least one field device can be serviced, wherein, for servicing, a first operating program is provided and the first operating program has a service program part corresponding to the specific application firmware,
a bus, via which the superordinated unit communicates with the at least one field device by means of the first operating program.

According to the invention, the object is achieved by features including that a field device has a basic firmware, by means of which a basic functionality of the field device is enabled, and that the field device is adaptable, respectively configurable, by a specific application firmware for a specific application. In this way, for example, a field device, which originally was configured by means of the specific application firmware for pressure measurement, can subsequently be retrofitted, respectively reconfigured, to become a fill-level measuring device. For this, only the corresponding specific application firmware needs to be installed. This opportunity for subsequently adapting the field device to an application provides, thus, to the user, respectively operator, of the field device an increased flexibility and, thus, an increased user friendliness.

The first operating program can be, for example, one of the operating tools mentioned above or a variation thereof. Serving as the service program parts can be corresponding DDs (Device Description) and/or a variation of such and/or DTMs.

An advantageous embodiment of the system of the invention provides that stored in a central unit are a number of specific application firmwares, as well as the service program parts corresponding to the respective application firmwares. By the central storing of the specific application firmwares and, thus, the construction of a library, the operator can obtain based on such library an easy overview of the available application firmwares.

An advantageous embodiment of the system of the invention provides that, based on a first distinguishing feature of the at least one field device, at least one of the plurality of application firmwares maintained in the central unit is associable with the at least one field device. The manufacturer-side predetermined, first distinguishing feature allows the associating of the application firmwares with corresponding field devices to be uniquely implemented and, thus, prevents inadvertent, erroneous installation.

An advantageous embodiment of the system of the invention provides that, based on a second distinguishing feature of the specific application firmware, at least one corresponding service program part is associable with the application firmware. Based on the second distinguishing feature, which is associated with the specific application firmware, the service program part necessary for servicing the field device can automatically be supplied to the first operating program. Thus, the first operating program is also correspondingly updated after a reconfiguration, respectively after an alteration, of the field device by means of the specific application firmware.

An advantageous embodiment of the system of the invention provides a mobile terminal device, in order to provide the specific application firmware to the field device. The service program part corresponding to the specific application firmware is correspondingly applied to adapt the first operating program.

An advantageous embodiment of the system of the invention provides that an electronic product code of the field device serves as first distinguishing feature.

is An advantageous embodiment of the system of the invention provides that the second distinguishing feature is a software identification number coming from the specific application firmware.

As regards the method, the object is achieved by a method for configuring a system of automation technology, especially process- and/or manufacturing automation technology, for a specific application, wherein the system includes at least one field device, which is configurable for a specific application via at least one specific application firmware, a superordinated unit, via which the at least one field device can be serviced by means of a first operating program adaptable by individual service program parts, and a bus, via which the superordinated unit communicates with the at least one field device, and wherein the method has at least steps as follows:
configuring the at least one field device for the specific application by means of the specific application firmware;
adapting the first operating program by means of a service program part corresponding to the specific application firmware of the at least one field device.

The terminology, configuring a field device, means, in such case, both the first installation of the field device at start-up in an automated plant as well as also the updating of a field device already integrated in an automated plant. In such case, the update can be performed both for expanding the existing specific application firmware, for example, for expanding the functionality of the field device, as well as also for changing the application of the field device.

An advantageous form of embodiment of the method of the invention provides that for configuring the field device for the specific application a central unit is accessed by means of a mobile terminal device and wherein the central unit provides the specific application firmware to the field device.

The mobile terminal device can, in principle, be any device, which has essentially the following three attributes. The first and simultaneously most important attribute is a capability for (wireless) data communication. The other two attributes are reachability and locatability. The performing of the method of the invention is, in such case, not limited to a particular mobile terminal device, but, instead, can be accomplished with any of a large number of mobile terminal devices, such as, for example, a smart phone, mobile telephone, laptop (with UMTS), tablet PC, PDA, netbook, UMPC, etc..

An advantageous form of embodiment of the method of the invention provides that by means of a first distinguishing feature of the respective field device the specific application firmware suitable for this field device and for the specific application is ascertained.

An advantageous form of embodiment of the method of the invention provides that based on a second distinguishing feature the service program part in the central unit corresponding to the specific application firmware is ascertained and the first operating program is correspondingly updated.

An advantageous form of embodiment of the method of the invention provides that the specific application firmware in the field device and/or the corresponding service program part in the first operating program are/is provided preferably by means of a mobile terminal device.

An advantageous form of embodiment of the method of the invention provides that a second operating program altered from the first operating program runs on the mobile terminal device and for serves servicing, especially local servicing, of the field device.

The invention will now be explained in greater detail based on the appended drawing, the sole figure of which shows as follows:

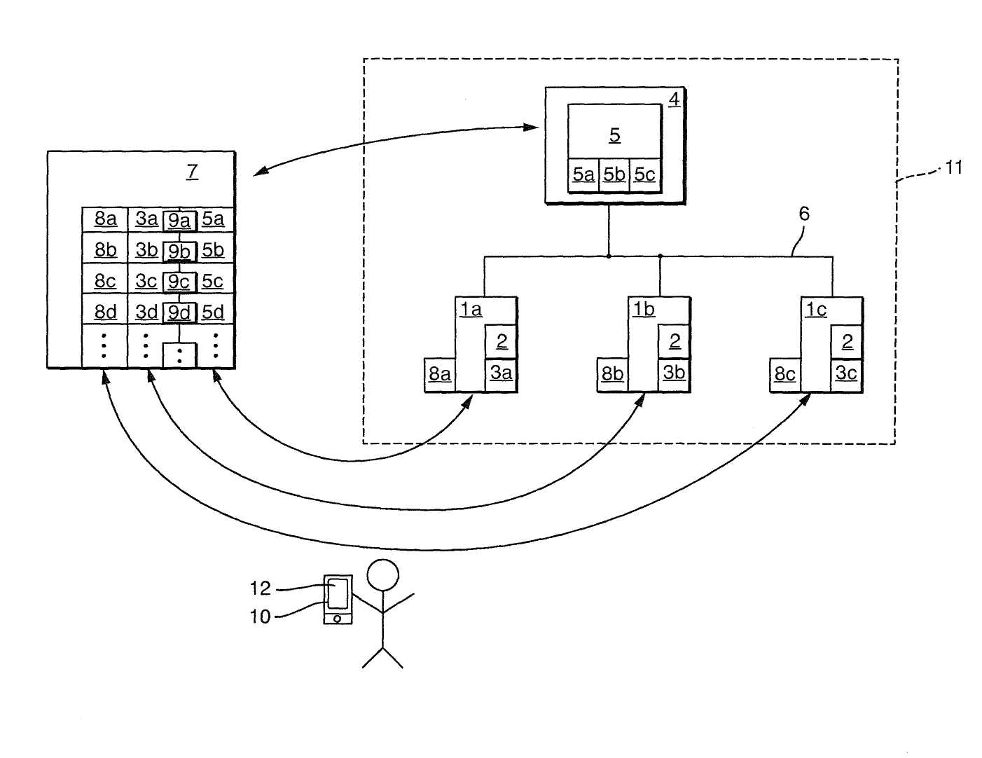

FIG. 1 a schematic representation of the system of the invention.

FIG. 1 shows, equipped with a basic firmware, three field devices 1a, 1b, 1c, which are configured for specific applications by means of specific application firmware 3a, 3b, 3c. For example, the first field device la is configured for fill level measurement, the second field device 1b for pressure measurement and the third field device 1c for flow measurement. The field devices 1a, 1b, 1c have, in such case, a basic firmware 2, by means of which the basic functionality of the respective field devices 1a, 1b, 1c is enabled. Building on this basic functionality, each field device 1a, 1b, 1c is then configured by means of a specific application firmware 3a, 3b, 3c for a corresponding application. Thus, for example, the first application firmware 3a serves for fill level measurement, the second application firmware 3b for pressure measurement and the third application firmware 3c for flow measurement.

The field devices 1a, 1b, 1c are connected by means of a bus 6 with a superordinated unit 4, which typically is a control unit. Bus 6 can be a fieldbus, such as above described, or a proprietary bus.

By means of the superordinated unit 4, the field devices 1a, 1b, 1c can be serviced via a first operating program 5, wherein the first operating program 5 has service program parts 5a, 5b, 5c corresponding to the specific application firmwares 3a, 3b, 3c. Thus, the first service program part 5a serves for servicing the first field device 1a, which is configured for a first application by means of the first application firmware 3a. The second service program part 5b serves for servicing the second field device 1b, which is configured for a second application by means of the second application firmware 3b. The same holds for all additional field devices.

Furthermore, FIG. 1 includes a central unit 7, in which the specific application firmwares 3a, 3b, 3c are held, respectively stored. Stored in the central unit 7 besides the specific application firmwares 3a, 3b, 3c are the service program parts 5a, 5b, 5c corresponding to the respective application firmwares 3a, 3b, 3c. By making the specific application firmwares 3a, 3b, 3c centrally available, the operator of an automated plant 11, respectively a service specialist, can access the central unit 7 and, at a glance, obtain an overview concerning which specific application firmwares 3a, 3b, 3c are available, in order, thus, to configure a corresponding field device 1a, 1b, 1c for an application. For example, a Web interface and/or an application for the mobile terminal device 10 can be provided for display.

In order to avoid a defective installation, respectively configuring, of a field device 1a, 1b, 1c with an application firmware 3a, 3b, 3c, the field devices have a first distinguishing feature 8a, 8b, 8c. The application firmwares 3a, 3b, 3c provided in the central unit 7 are linked, and, thus, associable, with appropriate field devices 1a, 1b, 1c based on this first distinguishing feature 8a, 8b, 8c. Preferably serving as first distinguishing feature 8a, 8b, 8c is an electronic product code of the respective field device 1a, 1b, 1c, which is typically assigned by the manufacturer of the field device 1a, 1b, 1c.

Besides the first distinguishing feature 8a, 8b, 8c, a second distinguishing feature 9a, 9b, 9c serves for associating the specific application firmwares 3a, 3b, 3c with the corresponding service program parts 5a, 5b, 5c. Especially, the second distinguishing feature 9a, 9b, 9c is a software identification number coming from the specific application firmware 3a, 3b, 3c. By means of this second distinguishing feature 9a, 9b, 9c, the application firmwares 3a, 3b, 3c held, respectively stored, in the central unit 7 are linked and, consequently, associable with the belonging service program part 5a, 5b, 5c. In this way, in the case of configuring a field device 1a, 1b, 1c with a specific application firmware 3a, 3b, 3c, the first operating program 5 can by means of the second detection feature 9a, 9b, 9c automatically load the corresponding service program part 5a, 5b, 5c and, thus, independently update.

FIG. 1 shows further a mobile terminal device, with the assistance of which the method of the invention is performable. Running on this mobile terminal device 10 for servicing, especially for local servicing, is a second operating program 12, which essentially equals the first operating program, only is adapted to the mobile terminal device.

For configuring a system of automation technology illustrated in FIG. 1, the method includes at least steps as follows:
configuring the at least one field device 1a, 1b, 1c for the specific application with the assistance of the specific application firmware 3a, 3b, 3c. For this, there is accessed by means of the mobile terminal device 10 the central unit 7, in order to provide the specific application firmware 3a, 3b, 3c to the field device 1a, 1b, 1c. This happens typically by means of the mobile terminal device 10. For example, the service specialist, who performs the configuration, displays on the mobile terminal device 10 the application firmwares 3a, 3b, 3c available for the specific field device 1a, 1b, 1c and selects the desired specific application firmware 3a, 3b, 3c as a function of the application. Whereupon the mobile terminal device 10 downloads the selected specific application firmware 3a, 3b, 3c and then transfers such to the corresponding field device 1a, 1b, 1c.
In order to prevent installing application firmwares 3a, 3b, 3c on incompatible field devices 1a, 1b, 1c, the method provides that, especially via the mobile terminal device 10, the first distinguishing feature 8a, 8b, 8c of the corresponding field device 1a, 1b, 1c is ascertained and then, with the assistance of the central unit 7, specific application firmware 3a, 3b, 3c suitable for this field device 1a, 1b, 1c are ascertained. A wireless short range communication such as, for example, “NFC” (Near Field Communication) and/or RFID (Radio Frequency IDentification) can be used for simpler automatic ascertaining of the first distinguishing feature 8a, 8b, 8c.
adapting the first operating program 5 by means of a service program part 5a, 5b, 5c corresponding to the specific application firmware 3a, 3b, 3c of the at least one field device 1a, 1b, 1c. For servicing the configured field device 1a, 1b, 1c via the first operating program 5, the second distinguishing feature 9a, 9b, 9c is used to ascertain in the central unit 7 the service program part 5a, 5b, 5c corresponding to the specific application firmware 3a, 3b, 3c and to update the first operating program 5 correspondingly. For this, after, respectively during, the configuring of the field device 1a, 1b, 1c, the second distinguishing feature 9a, 9b, 9c is transmitted to the first operating program 5, is respectively requested by such, and then the first operating program 5 accesses, for example, via the superordinated unit 4, the central unit 7 and ascertains based on the second distinguishing feature 9a, 9b, 9c the service program part 5a, 5b, 5c required for servicing. This is then independently downloaded and, thus, provided in, respectively to, the first operating program 5, in order correspondingly to adapt such. In this way, an automatic adapting of the first operating program is accomplished.

### LIST OF REFERENCE CHARACTERS

1a, 1b, 1c, . . . field device
2 basic firmware
3a, 3b, 3c, . . . application firmware
4 superordinated unit
5 first operating program
5a, 5b, 5c, . . . service program part
6 bus
7 central unit
8a, 8b, 8c, . . . first distinguishing feature
9a, 9b, 9c, . . . second distinguishing feature
10 mobile terminal device
11 automated plant
12 second operating program

1-13. (canceled)

14. A system for use in automation technology, especially in process and/or manufacturing automation technology, comprising:
at least one field device equipped with a basic firmware, said field device is configurable for a specific application by means of a specific application firmware;
a superordinated unit, via which the at least one field device can be serviced;
a first operating program for servicing, said first operating program has a service program part corresponding to said specific application firmware; and
a bus, via which said superordinated unit communicates with the at least one field device by means of said first operating program.

15. The system as claimed in claim 14, further comprising:
a central unit, wherein:
a plurality of specific application firmwares as well as service program parts corresponding to said respective application firmwares are stored in said central unit.

16. The system as claimed in claim 15, wherein:
based on a first distinguishing feature of said at least one field device, at least one of said plurality of application firmwares in said central unit is associable with the at least one field device.

17. The system as claimed in claim 16, wherein:
based on a second distinguishing feature of said specific application firmware, at least one corresponding service program part is associable with said specific application firmware.

18. The system as claimed in claim 14, further comprising:
a mobile terminal device, wherein said mobile terminal device is provided, in order to provide said specific application firmware to said field device, and
said first operating program is adapted to said specific application firmware by means of said corresponding service program part.

19. The system as claimed in claim 16, wherein:
an electronic product code of the field device serves as said first distinguishing feature.

20. The system as claimed in claim 17, wherein:
said second distinguishing feature is a software identification number coming from said specific application firmware.

21. A method for configuring a system of automation technology, especially process- and/or manufacturing automation technology, for a specific application, wherein the system includes at least one field device, which is configurable for a specific application via at least one specific application firmware, a superordinated unit, via which the at least one field device can be serviced by means of a first operating program adaptable by individual service program parts, and a bus, via which the superordinated unit communicates with the at least one field device, and wherein the method at least comprises the steps of:
configuring the at least one field device for the specific application by means of the specific application firmware; and
adapting the first operating program by means of a service program part corresponding to the specific application firmware of the at least one field device.

22. The method as claimed in claim 21, wherein:
for configuring the field device for the specific application, a central unit is accessed by means of a mobile terminal device; and
the central unit provides the specific application firmware to the field device.

23. The method as claimed in claim 21, wherein:
by means of a first distinguishing feature of the respective field device the specific application firmware suitable for this field device is ascertained.

24. The method as claimed in claim 21, wherein:
based on a second distinguishing feature the service program part in the central unit corresponding to the specific application firmware is ascertained and the first operating program is correspondingly updated.

25. The method as claimed in claim 21, wherein:
the specific application firmware in the field device and/or the corresponding service program part in the first operating program are/is provided by means of a mobile terminal device.

26. The method as claimed in claim 21, wherein:
a second operating program altered from the first operating program runs on the mobile terminal device.
